(19) United States
(12) Patent Application Publication
(10) Pub. No.: US 2020/0005244 A1
(43) Pub. Date: Jan. 2, 2020

(54) DISCOVERING RELATED ORGANIZATIONS THROUGH DIFFERENT TYPES OF ONLINE CONNECTIONS

(71) Applicant: Microsoft Technology Licensing, LLC, Redmond, WA (US)

(72) Inventors: Shen Huang, San Jose, CA (US); Quan Wang, San Mateo, CA (US); Huan Hoang, San Jose, CA (US); Yongzheng Zhang, San Jose, CA (US); Chi-Yi Kuan, Fremont, CA (US)

(21) Appl. No.: 16/022,492

(22) Filed: Jun. 28, 2018

(51) Int. Cl. G06Q 10/10; G06F 17/30; G06N 5/02

(52) U.S. Cl. CPC G06Q 10/1053; G06N 5/02; G06F 17/30876

(57) ABSTRACT

Techniques for discovering related organizations through different types of online connections are provided. In one technique, connection data is stored that identifies, for each user in a first set of users, one or more other users with which that user has a connection. Job change data is stored that identifies, for each user of a second set of users, multiple organizations for which that user has worked or had sought an employment relationship. Based on the connection data, a number of connections between employees of a first organization and employees of a second organization is identified. Based on the job change data, a number of users that listed, in their respective online profiles, the first organization as an employer is identified. Based on the number of connections and the number of users, a determination of whether the first organization and the second organization are related is made.

### TECHNICAL FIELD

The present disclosure relates to online communication networks and, more particularly, to analyzing certain types of online connections to discover related organizations.

### BACKGROUND

Knowing that two organizations are related is valuable for multiple reasons. For example, such knowledge can be used by recruiters to identify potential candidates and to monitor talent flow among competing companies. As another example, such knowledge can be used by candidates to find appropriate job openings and learning courses. As a further example, such knowledge can be used by search engine bots to crawl relevant pages. The quality of data about related companies directly impacts the effectiveness of those tasks.

One approach for relating companies with each other is a manual approach. For example, a human is presented with the names of two organizations and provides input indicating whether they are related. However, a manual approach is labor-intensive, expensive, error prone, and not data driven. Thus, a human may make mistakes. Even if a person does not make a mistake when a relation determination is made, two organizations may become more (or less) related over time. For example, one organization may begin to develop a competing product or service relative to another organization. As another example, employees of one organization in one industry may begin to migrate to organizations in a different industry.

One automatic approach for determining that two organizations are related is to use content features, such as description found on profile pages and job postings of the respective organizations. If the similarity between the descriptions is high, then the likelihood that the respective organizations are related is high. However, a downside to this approach is that such textual descriptions are easily manipulated. For example, some organizations may copy phrases or terminology of a highly regarded organization in crafting their own profiles, job postings, etc.

Another automatic approach for determining that two organizations are related is to leverage user feedback. For example, if a user browses information about three organizations in a single session, then the three organizations may be deemed related to each other. From such user behavior, collaborative filtering models may be built to capture the potential relatedness of different organizations. However, a downside to this approach is that fraudulent user clicks relative to two organizations may cause both organizations to be considered related, when in fact they are not.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for determining relations among organizations, in an embodiment;

FIG. 2 is a block diagram that depicts an example social network of people connections among multiple organizations, in an embodiment;

FIG. 3 is a block diagram that depicts an example of people movement among multiple organizations, in an embodiment;

FIG. 4 is a flow diagram that depicts a process for determining whether two organizations are related, in an embodiment;

FIG. 5 is a block diagram that depicts an example framework for a machine learning based weight optimization, in an embodiment;

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for automatically determining relatedness of two organizations are provided. In one technique, two types of connections are considered: people connections and employment connections. A people connection is an online connection between two employees from different organizations. People connections (especially ones between people with a long history on an online social network) is difficult to deceive. The more people connections there are between two organizations, the more likely that the two organizations are related. An employment connection is a connection between a single user and multiple organizations and is reflected in an online profile of the user. If a user has moved from one organization to another organization, then there is an employment connection between the two organizations. Also, if a user has applied to a particular organization, then an employment connection may be inferred. The more employment connections between two organizations, the more likely that the two organizations are related. Hence, this process for determining relatedness of two organizations is not reliant on the labor-intensive process of requiring user input as to organizational relatedness. Further, because these different types of data are aggregated from a relatively large number users, the less vulnerable the data is to malicious manipulation by bad actors to incorrectly achieve relatedness between organizations.

### System Overview

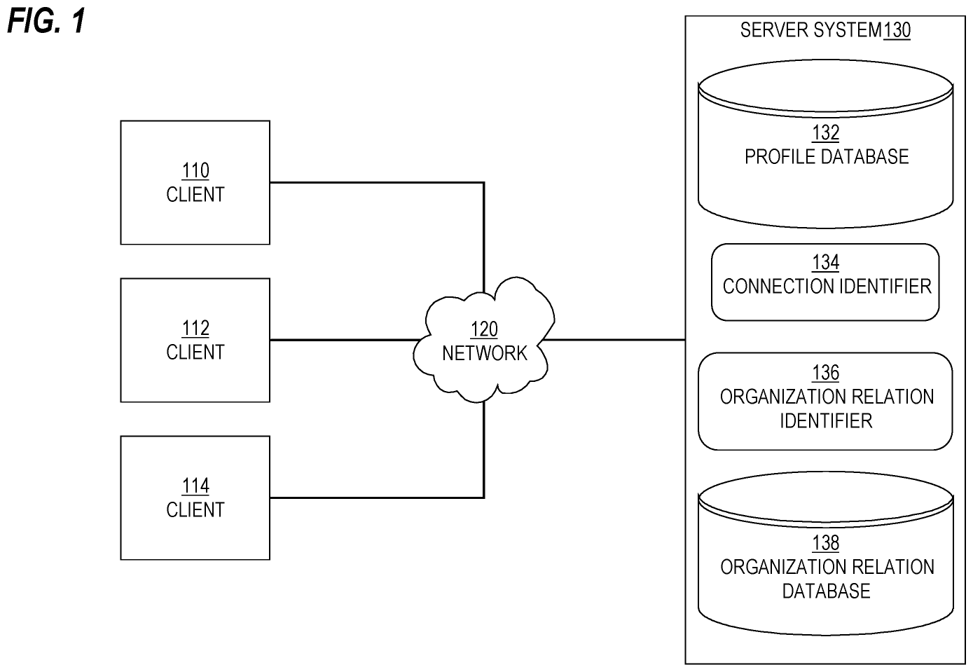

FIG. 1 is a block diagram that depicts a system 100 for determining relations among organizations, in an embodiment. System 100 includes clients 110-114, network 120, and server system 130.

Each of clients 110-114 is an application or computing device that is configured to communicate with server system 130 over network 120. Examples of computing devices include a laptop computer, a tablet computer, a smartphone, a desktop computer, and a Personal Digital Assistant (PDA). An example of an application includes a dedicated application that is installed and executed on a local computing device and that is configured to communicate with server system 130 over network 120. Another example of an application is a web application that is downloaded from server system 130 and that executes within a web browser executing on a computing device. Client 110 may be implemented in hardware, software, or a combination of hardware and software. Although only three clients are depicted, system 100 may include many clients that interact with server system 130 over network 120.

Through each of clients 110-114, a user is able to provide input that includes profile information about the user. Later, the user may interact with server system 130 to retrieve, supplement, and/or update the profile information. Also, through a client, a user is able to initiate requests, to server system 130, (a) to establish connections with one or more other users of server system 130 and/or (b) for web content.

Network 120 may be implemented on any medium or mechanism that provides for the exchange of data between clients 110-114 and server system 130. Examples of network 120 include, without limitation, a network such as a Local Area Network (LAN), Wide Area Network (WAN), Ethernet or the Internet, or one or more terrestrial, satellite or wireless links.

### Server System

As depicted in FIG. 1, server system 130 includes a profile database 132, a connection identifier 134, an organization relation identifier (ORI) 136, and organization relation database 138. Connection identifier 134 and organization relation identifier (ORI) 136 are implemented in software, hardware, or any combination of hardware and software.

In an embodiment, profile database 132 comprises multiple user profiles, each provided by a different user. In this embodiment, server system 130 maintains accounts for multiple users. Server system 130 may provide a web service, such as a social networking service. Examples of social networking service include Facebook, LinkedIn, and Google+. Although depicted as a single element, server system 130 may comprise multiple computing elements and devices, connected in a local network or distributed regionally or globally across many networks, such as the Internet. Thus, server system 130 may comprise multiple computing elements other than connection identifier 134 and ORI 136.

Profile database 132 is stored in a storage that may comprise persistent storage and/or volatile storage. The storage may comprise a single storage device or multiple storage devices. The storage may be part of server system 130 (as implied in FIG. 1) or may be accessed by server system 130 over a local network, a wide area network, or the Internet.

A user's profile may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, connections of the user, and derived data that is based on actions that the candidate has taken. Examples of such actions include jobs to which the user has applied, views of job postings, views of company pages, private messages between the user and other users in the user's social network, and public messages that the user posted and that are visible to users outside of the user's social network. Online user actions may be stored separately from, but is otherwise associated with (e.g., through a unique user identifier), profile database 132.

Some data within a user's profile (e.g., work history) may be provided by the user while other data within the user's profile (e.g., skills and endorsement) may be provided by a third party, such as a “friend” or connection of the user or a colleague of the user.

Before profile database 132 is analyzed, server system 130 may prompt users to provide profile information in one of a number of ways. For example, server system 130 may have provided a web page with a text field for one or more of the above-referenced types of information. In response to receiving profile information from a user's device, server system 130 stores the information in an account that is associated with the user and that is associated with credential data that is used to authenticate the user to server system 130 when the user attempts to log into server system 130 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, server system 130 stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by server system 130. For example, a user specifies, in his/her profile, a name of the user's employer. Server system 130 determines, based on the name, where the employer and/or user is located. If the employer has multiple offices, then a location of the user may be inferred based on an IP address associated with the user when the user registered with a social network service (e.g., provided by server system 130) and/or when the user last logged onto the social network service.

### People Connections

With respect to two organizations, a “people connection” is a connection between employees of the two organizations. Connection identifier 134 determines an employment relationship with an organization by analyzing the name of an employer in a user's profile. Connection identifier 134 determines a friend relationship between two users by analyzing a friend or connection list of one of the users and determining that the other user is listed in the friend/connection list (which may comprise a list of user or account identifiers). Two organizations have a people connection is an employee of one of the organizations is a friend/connection of an employee of the other organization. The more people connections there are between two organizations, the more likely that both organizations are related.

An organization may be any type of organization, such a company (examples of which include a proprietorship, a partnership, and a corporation), a government agency, an academic institution, a non-profit organization, and a charitable organization.

People tend to form professional connections with (a) colleagues in the same or similar industry and (b) business relations. For example, people may connect with alumni and colleagues/business partners/attendees of the same conference. People are also likely to work for similar companies. Once people connections are aggregated with respect to two organizations, an organization relation may be clearly revealed.

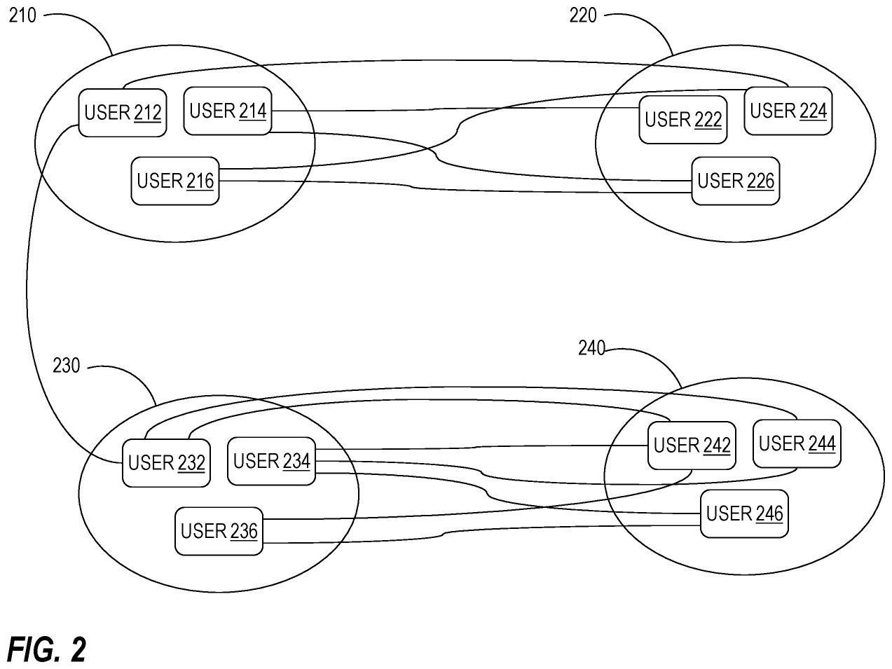

FIG. 2 is a block diagram that depicts an example social network 200 of people connections among multiple organizations 210-240, in an embodiment. Each of organizations 210-240 has multiple employees. This example depicts that there are five people connections between organizations 210 and 220, one people connection between organizations 210 and 230, and seven people connections between organizations 230 and 240. Thus, based on frequency of people connections alone, organizations 230 and 240 have the highest degree of relation.

A people connection may be symmetric or asymmetric. A symmetric connection is one where each individual of a connection confirmed to be a friend or connection of the other individual. An asymmetric connection is one where only one of the individuals confirmed to follow or subscribe to information from the other individual. The social network of Twitter is an example of asymmetric connections where many people may “follow” a particular user without that particular user having to affirm the relationship. Thus, the particular user does not necessarily follow any of the particular user's followers. However, if the particular user did follow one of his/her followers, then the two users may be considered a symmetric connection.

In an embodiment, one or more criteria is used to determine whether two organizations are related. One of the criteria includes frequency or number of people connections. If the number of people connections between two organizations is above a particular threshold, then the two organizations are considered to be related. In a related embodiment, different industries have different thresholds.

In a related embodiment, size of an organization is a factor in determining whether two organizations are related. If not, then even a relatively few number of people connections between two relatively large organizations (e.g., 10,000+ employees) might cause ORI 136 to identify those two organizations as related. By taking into account the size of one or both of the organizations, a more accurate determination may be made. For example, if the ratio of (1) the number of people connections between two organizations to (2) the number of employees of one of the organizations is greater than a particular threshold (e.g., 1/20 or 5%), then the two organizations are considered related. The number for (2) may be the larger organization or the smaller organization. The number for (2) may be determined by analyzing user profiles that list one of two organizations in the respective user profiles as an employer.

Organization size may be determined in one or more ways. For example, size of an organization may be determined by totaling the number of users that list that organization as an employer in their respective user profiles. As another example, size of an organization may be determined based on a size listed on the organization's profile page. As another example, size of an organization may be determined based on extracting size data from a third-party source, such as an SEC listing, a Wikipedia page, or an article found on a third-party web site.

In an embodiment, an organization relation may be symmetric or asymmetric. For example, a first organization may be designated as related to a second organization but not vice versa. For example, ORI 136 determines that the first organization has 20 employees, the second organization has 10,000 employees, and there are 10 people connections between the two organizations (based on analysis of connection identifier 134). Based on the ratio of 10/20, ORI 136 determines that the first organization is related to the second organization. However, based on the ratio of 10/10,000, ORI 136 determines that the second organization is not related to the first organization. This may be the case if, for example, both organizations are in the same industry, the first organization is spin off of the second organization but offers only a single targeted service while the second organization offers many services.

In some cases, many (e.g., thousands or tens of thousands) users might list a particular organization as their employer. Thus, determining people connections between that particular organization and each other possible organization may take a significant amount of time and require significant computing resources. Therefore, in an embodiment, a sampling of users (e.g., a maximum of five hundred) that list an organization in their respective profiles is performed. Then, the number of people connections between two organizations may be determined from that sampling. For example, if there are 20 people connections determined from a sampling and one of the organizations was sampled by considering only five hundred connections, and it is known that the organization has five thousand employees, then the number of estimated people connections may be determined as follows: 20*(5,000/500)=200. This approach reduces the amount of computing resources utilized and time to compute an organization relation.

### Weighted People Connections

In an embodiment, different people connections have different weights. Thus, some people connections are weighted higher than other people connections. For example, common values for certain user profile attributes are weighted higher than others. Examples of such profile attributes include industry, job title, job function, academic institution, and geographic location. Some of these attributes may be weighted higher than others. For example, the fact that two connected users list the same job title in their respective profiles is weighted higher than if the two connected users list the same geographic location (or the same academic institution) in their respective profiles. As another example, if two users of a people connection share the same last name (particularly uncommon names), then such a people connection is weighted lower because it may be presumed that the people connection is primarily a familial connection rather than a business connection.

In an embodiment, online behavior of two user of a people connection may cause a weight for that connection to increase. Examples of online behavior is a number of online messages sent between the two users (e.g., through a messaging service provided by server system 130), a number of views by one user of the other user's profile, a recency of such online actions (e.g., more recent actions are weighted higher than older actions), one user providing an endorsement of the other user (to be placed in the other user's public profile), and one user interacting with online connect associated with the other user. Examples of “online interactions” include commenting on, “liking,” or “sharing” another user's online article/post. Some online interactions by one user relative to another user may be weighted higher than other online interactions.

### Employment Connections

With respect to two organizations, an “employment connection” is a connection or association between two organizations based on a single user's employment-related actions relative to those two organizations. An employment-related action includes working for an organization (which can be determined by analyzing the name of an employer in the user's profile), applying for a job provided by the organization, and viewing one or more job postings regarding jobs provided by the organization. For example, if a user lists a first organization as an employer in his/her user profile and then lists a second organization as an employer in his/her user profile, then an employment connection between the first organization and the second organization is identified. As another example, if a user lists a first organization as an employer in his/her user profile and then applies for a job provided by a second organization, then an employment connection between the first organization and the second organization is identified. The more employment connections there are between two organizations, the more likely that both organizations are related.

Connection identifier 134 determines whether an employment connection between two organizations exists. Thus, connection identifier 134 determines the two different types of connections. Alternatively, server system 130 includes two different connection identifiers: (1) a people connection identifier for identifying people connections and (2) a employment connection identifier for identifying employment connections.

A user applying for a job may be determined in one or more ways. For example, job postings are hosted on server system 130 and a user (e.g., operating client 110) selects a particular job posting to view and content (e.g., within a web page) that includes the job posting also includes a link (e.g., in the form of a graphical button) to apply. By selecting the link, the user's information (e.g., certain profile attribute values from the user's profile) is automatically transmitted to an account of the corresponding organization. The account may also be hosted by server system 130, or may be hosted by a third-party system, such as one that is maintained or owned by the organization. The transmission of the profile attribute values is tracked by server system 130.

As another example, a user sends, to a recruiter or a representative of an organization, an electronic message using a messaging service provided by server system 130. The message indicates that the user is applying for a job provided by the organization. Such a message may be tracked by server system 130. As a similar example, both a recruiter and a candidate may interface with a job-related system (offered by server system 130) that allows each to view the other's actions, such as submitting a job application.

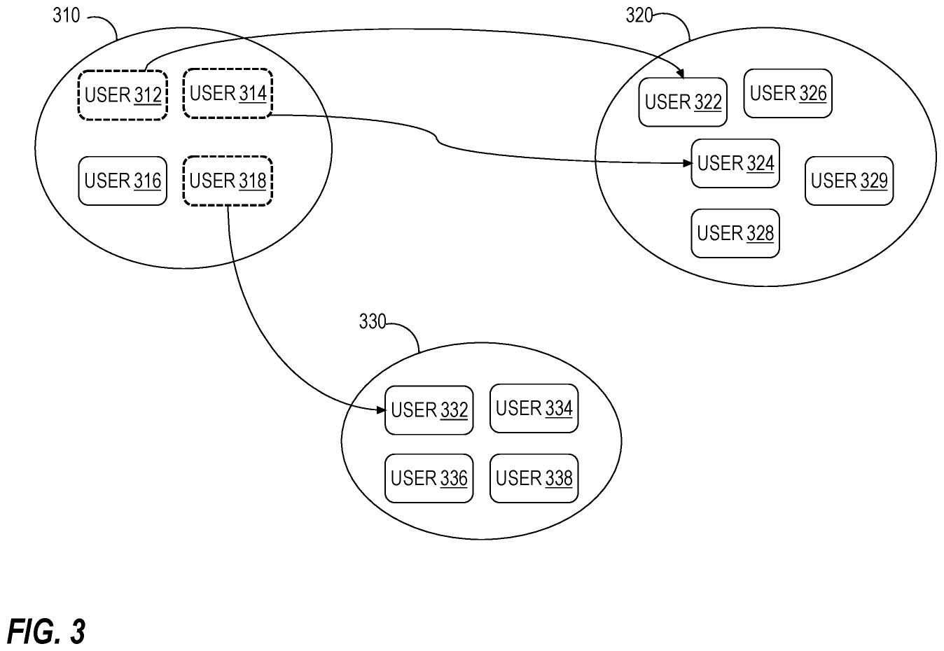

FIG. 3 is a block diagram that depicts an example of people movement among multiple organizations 310-330, in an embodiment. Each of organizations 310-330 has multiple employees. This example depicts that two people (users 312 and 314) moved from organization 310 to organization 320 and one person (user 318) moved from organization 320 to organization 330. Based on frequency of employment connections alone, organizations 310 and 320 have a higher degree of relation than organizations 310 and 330.

In an embodiment, some employment connections are weighted higher than others. Such a difference in weighting may be based on employment-related actions that are analyzed to identify an employment connection. For example, a user viewing a job posting associated with an organization (even though the system can be confident that the user is a legitimate user and is acting reasonably) may be weighted less than a user applying for a job provided by an organization, which may be weighted less than a user working for that organization.

Also, there may be an inverse correlation between length of time spent employed by one organization and strength or weight of an associated employment connection. For example, an employment connection between a first organization and second organization where a user that lists (in his/her profile) the first organization for a relatively long period of time (e.g., greater than seven years) may have a lower weight than an employment connection between the two organizations where a user lists the first organization for a lesser period of time (e.g., less than five years).

Additionally, employment connections that occurred relatively recently (e.g., within the last year) may have a higher weight than employment connections that occurred longer ago. Thus, a decay-with-time rate may be applied to each employment connection to determine a weight of that employment. The decay-with-time rate may be reflected in a linear function, a logarithm function, an exponential function, or any other type of function.

In an embodiment, an employment connection may be symmetric or asymmetric. For example, a first organization may be designated as related to a second organization but not vice versa. This may be the case if, for example, many users have moved from one organization to another, but not vice versa. For example, ORI 136 determines that two hundred former employees of a first organization changed employers and are now employed by a second organization, but only five former employees of the second organization changed employers and are now employed by the first organization. In this example, the employment (or talent) flow is from the first organization to the second organization. Thus, ORI 136 may determine that the second organization is related to the first organization but determines that the first organization is not related to the second organization.

In an embodiment, similar to people connections, employment connections between two organizations may be normalized based on the size of one or both of the organizations. For example, ORI 136 determines that a first organization has 20 employees, a second organization has 10,000 employees, and there are 10 employment connections between the two organizations. Based on the ratio of 10/20, ORI 136 determines that the first organization is related to the second organization. However, based on the ratio of 10/10,000, ORI 136 determines that the second organization is not related to the first organization.

ORI 136 stores results in organization relation database 138 as records, each record containing two organization identifiers (e.g., a name, or randomly generated alphanumeric value). Organization relation database 138 may contain only affirmative results (i.e., that two organizations are related) or both affirmative results and negative results (i.e., that two organizations are not related).

Another component of server system 130 (not shown) requests information from organization relation database 138. A request may include a single organization identifier/name, two organization identifiers/names, or a list of organization identifiers/names. A request that includes a single organization identifier may implicitly ask for all organization identifiers/names that are considered related (e.g., by ORI 136) to the organization identified by the organization identifier. A request that includes two organization identifiers may implicitly ask for whether the two organizations identified by the organization identifier are related. A request that includes a list of organization identifiers may implicitly ask for, for each organization identified by an organization identifier in the list, all organization identifiers/names that are considered related to that organization.

The records in organization relation database 138 may be ordered based on organization identifier, organization name, or any other ordering criteria. The records in organization relation database 138 pairs may be indexed such that a table scan of each record is not necessary to (a) determine whether two organizations are related or (b) identify all relations pertaining to a particular organization.

### Example Process

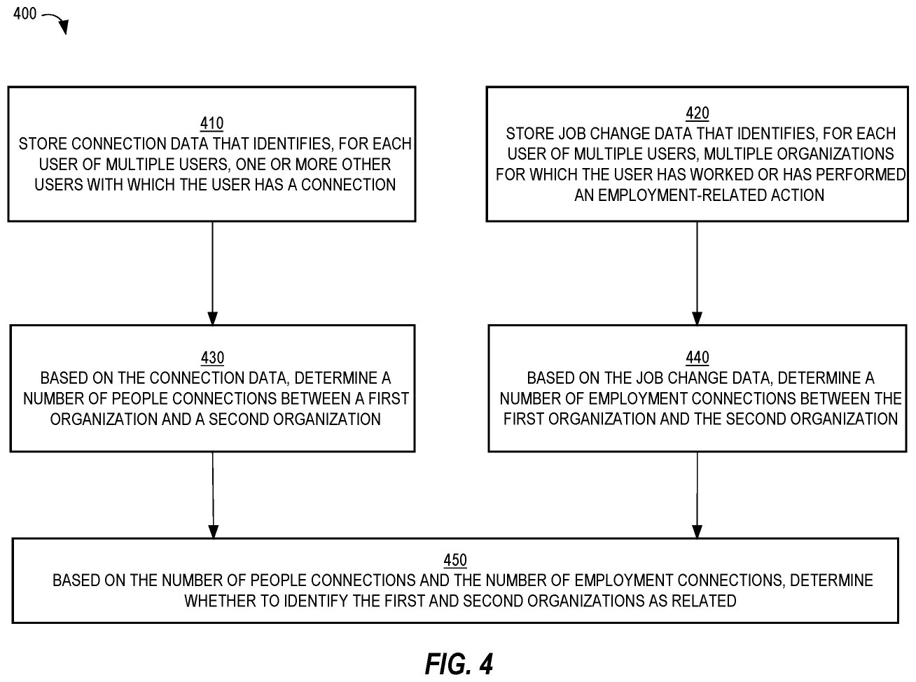

FIG. 4 is a flow diagram that depicts a process 400 for determining whether two organizations are related, in an embodiment. Process 400 may be implemented by server system 130 and, more particularly, by components of server system 130, such as connection identifier 134 and organization relation identifier (ORI) 136.

At block 410, connection data is stored that identifies, for each user of multiple users, one or more other users with which the user has a connection. The connection data may be reflected in user profiles stored in profile database 132.

At block 420, job change data is stored that identifies, for each user of multiple users, multiple organizations for which the user has worked or had performed an employment-related action (e.g., applied for a job or sought an employment-related relationship). Such job change data may be reflected in user profiles stored in profile database 132 (such as analyzing current and prior employer fields). Alternatively, job change data may be stored separately from any user profile but that associates, for each user, one or more organizations that employed the user and, optionally, one or more organizations that provided jobs (a) to which the user applied or (b) that were described in job postings that the user viewed. Either way in which job change data is stored, a date information may be stored that indicates when the user began working for an organization and, optionally, a length of time that the user was employed by that organization.

At block 430, based on the connection data, a number of people connections (i.e., connections between employees of a first organization and employees of a second organization) is determined. Block 430 may be performed by connection identifier 134. The two organizations that are selected for block 430 may be any random set of organizations. Thus, block 430 may be performed multiple times given the same connection data, but for different pairs of organizations.

At block 440, based on the job change data, a number of employment connections between the first organization and the second organization is determined. While the logic of block 430 is different than the logic of block 440, block 440 may also be performed by connection identifier 134. The two organizations that are considered for block 440 are the same as the organizations considered in block 430. Thus, block 440 may be performed multiple times given the same people connection data, but for different pairs of organizations. Also, blocks 430-440 may be performed in any order or concurrently.

At block 450, based on the number of people connections determined in block 430 and the number of employment connections determined in block 440, it is determined whether to identify the first organization and the second organization as related organizations. Block 450 may involve determining (based on asymmetric people connections and/or employment connections) that one organization is related to the other but not vice versa. Block 450 may be performed by ORI 136A.

Process 400 may revert to block 430 to identify a different pair of organizations that have yet been considered.

Blocks 430-450 may be performed multiple times with respect to a particular pair of organizations, such as daily, weekly, or monthly. Thus, for example, even though after one iteration of blocks 430-450 that involves determining that a first organization is not related to a second organization, a later iteration of blocks 430-450 may involve determining that the first organization is related to the second organization. This may be the result of more people moving from one of the organizations to the other or existing connected users (e.g., from the same school) joining the respective organizations.

The converse is also true: even though after one iteration of blocks 430-450 that involves determining that a first organization is related to a second organization, a later iteration of blocks 430-450 may involve determining that the first organization is not related to the second organization. This may be the result of the prior people and/or employment connections no longer existing as employees of one organization change employers.

In an embodiment, process 400 does involves either block 430 or block 440, but not both, regarding at least one pair of organizations. Thus, block 450 is based on either people connections or employment connections, but not both.

Though not described with respect to blocks 430 and 440, those blocks may involve weighting different people connections differently and/or weighting different employment connections differently, based on criteria described previously.

### Analyzing Sets of Potentially Related Organizations

The above description of process 400 implies that a pair of organizations is determined one at a time. Alternatively, block 430 involves identifying a first set of organizations that are related to a particular organization based on people connections and block 440 involves identifying a second set of organizations that are related to the particular organization based on employment connections. Each set is ordered based on frequency and the respective types of connections may be weighted. Block 450 may then involve taking the top N organizations from the first set and taking the top M organizations from the second set and using those respective lists of organizations to determine a set of organizations that is related to the particular organization. (N and M may be the same value or different values.) For example, each organization in the top N is considered related to the particular organization and each organization in the top M is considered related to the particular organization. As another example, only organizations that are in both the top N and the top M are considered related to the particular organization. As another example, without taking the top N or top M organizations, the rankings of each organization in both sets are combined to generate a score for the organization. Any organization with a score above (or below) a certain threshold is considered related to the particular organization.

In a related embodiment, different industries are associated with different N_{S} and/or M_{S}. For example, some industries may have a lot of organizations while other industries may have few organizations. Additionally or alternatively, the size of N and M varies based on the size of the particular organization. For example, the smaller the organization (in terms of employees and, optionally, profitability, revenues, market share), the smaller the values of N and M. Conversely, the larger the organization, the larger the values for N and M.

### Use Cases

As noted previously, determining that two organizations are related may be used in multiple ways. For example, if an entity that operates server system 130 sells a product or service to one organization, it would be helpful for the entity to know what other organizations are related to that organization and are, therefore, more likely to purchase that product/service. Similarly, sales representatives of a particular company leverage a service provided by server system 130 to view profiles of companies and other organizations and profiles of users who work at those organizations and to communicate with those users. The service may present a feature that allows the sales representatives to view organizations that are determined to be related to a particular organization that a sales representative searched, viewed, messaged (i.e., an employee at the particular organization), or otherwise interacted with. Similarly, if an entity already sells to two related organizations and one organization has a much larger contract (e.g., in revenue) with the entity than the other organization has with the entity, then the entity may see that the other organization represents an opportunity for the entity to increase that contract.

As another example, if a user lists, in his/her online profile, a particular organization as a current employer, then server system 130 can present, in the user's news or homepage feed, job postings of organizations determined to be related to the particular organization.

As another example, if a user views a company page of a particular organization, then server system 130 can present, on that company page, job postings of organizations determined to be related to the particular organization. Similarly, if a first user views a profile page of a second user that lists, in the second user's online profile, a particular organization as a current employer, then server system 130 can present, on that profile page, job postings of organizations determined to be related to the particular organization.

By including links from one page associated with one organization to another page associated with a related organization, another benefit (in addition to providing potentially relevant content to end users) is that users will most likely select (e.g., click on) those links, which increases their respective page ranks calculated by third-party search engines. In other words, search engine optimization (SEO) of the pages host is benefited through these better linked pages.

As another example, if employees from a first organization are viewing particular content (e.g., an online video course), then such content may be recommended (e.g., by server system 130) to employees of a second organization that is determined to be similar to the first organization.

Different use cases may benefit from one type of connection (e.g., people connections) over another type of connection (e.g., employment connections). For example, in a sales scenario, people connections may be given more weight than employment connections, which may not be given any weight at all in determining whether two organizations are related. As another example, in providing job recommendations to users of a particular organization, employment connections (particularly asymmetric employment connections) from the particular organization to another organization may be given more weight than people connections, which may not be given any weight at all in determining whether the two organizations are related. Thus, for one use case, two organizations may be related, but, for another use case, the two organizations are not related.

### Machine Learning Approach

In an embodiment, one or more related organization classification models are generated based on training data using one or more machine learning techniques. Machine learning is the study and construction of algorithms that can learn from, and make classifications on, data. Such algorithms operate by building a model from inputs in order to make data-driven classifications. Thus, a machine learning technique is used to generate a classification model that is trained based on a history of attribute values associated with users and connections. The classification model is trained based on multiple attributes (or factors) described herein. In machine learning parlance, such attributes are referred to as “features.” To generate and train a classification model, a set of features is specified and a set of training data is identified.

Embodiments are not limited to any particular machine learning technique for generating a classification model. Example machine learning techniques include linear regression, logistic regression, random forests, naive Bayes, and Support Vector Machines (SVMs). Advantages that machine-learned classification models have over rule-based classification models include the ability of machine-learned classification models to output a probability (as opposed to a number that might not be translatable to a probability), the ability of machine-learned classification models to capture non-linear correlations between features, and the reduction in bias in determining weights for different features.

As noted above, a linear combination of people connections and employment connections may be used to determine whether two organizations are related. While the above description implies that both types of connections may be considered equally (and, thus, weighted equally), a weight may be applied to one of the two types of connections to reflect that one type of connection is more important than the other type of connection. For example, the number of employment connections may have a weight of two, indicating that employment connection is twice as important as a people connection. Such a weight may be determined manually or automatically through one or more machine learning techniques.

Example features for a machine-learned classification model include:
a. a number of people connections
b. a number of people connections where the connected users have formed a connection with each other in the last period of time (e.g., two years)
c. a number of people connections where the connected users have communicated with each other through a messaging service
d. a number of people connections where at least one of the connected users has viewed the other user's public profile
e. a number of people connections where at least one of the connected users has commented, shared, or liked content authored by the other user and published through server system 130
f. a ratio of the number of people connections to a size of one of the two organizations
g. a number of employment connections
h. a number of employment connections that formed in the last period of time (e.g., one year)
i. a number of employment connections where one of the organizations was only applied to
j. a ratio of the number of employment connections to a size of one of the two organizations
k. a size of a time window for a decay period

An actual classification model may have more, less, or different features. Initially, each feature is associated with a weight or coefficient, which may be selected randomly and may be bounded by certain values (e.g., within −1 and 1 or within 0 and 5).

The training data comprises multiple training instances, each training instance (1) corresponding to a pair of organizations, (2) including a value for each feature of multiple features (such as the features described above), and (3) including a label that indicates whether the pair of organizations are related. The label may be manually set, but the feature values may be automatically calculated in order to generate the remainder of the training data.

### Example Machine Learning Framework

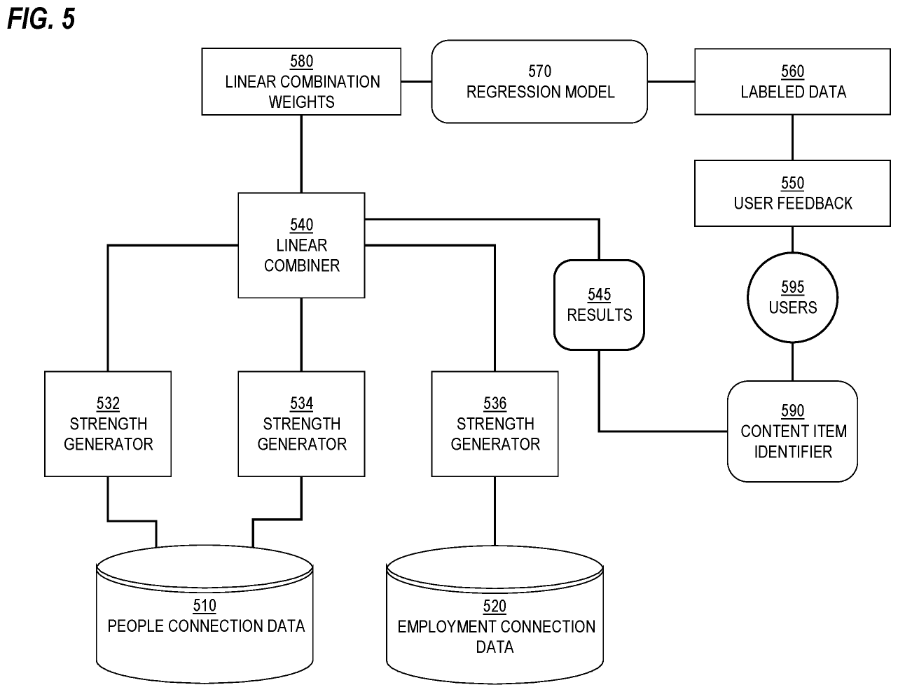

FIG. 5 is a block diagram that depicts an example framework 500 for a machine learning based weight optimization, in an embodiment. Framework 500 includes people connection data 510, employment connection data 520, strength generators 532-536, a linear combiner 540, user feedback 550, labeled data 560, a regression model 570, linear combination weights 580, and final results 590.

People connection data 510 may be an intermediate stage where multiple user profiles are analyzed to identify people connections for multiple pairs of organizations. Similarly, employment connection data 520 may be an intermediate stage where multiple user profiles (and/or employment-related activities) are analyzed to identify employment connections for multiple pairs of organizations.

Each of strength generators 532-536 calculate a strength for each connection in one of people connection data 510 or employment connection data 520. For example, symmetrical strength generator 532 accepts symmetrical people connections as input from people connection data 510 and generates, for each symmetrical people connection, a strength value indicating how strong the connection is. Similarly, asymmetrical strength generator 534 accepts symmetrical people connections as input from people connection data 510 and generates, for each asymmetrical people connection, a strength value indicating how strong the connection is. The factors that are considered by asymmetrical strength generator 534 may be different than the factors that are consider by symmetrical strength generator 532.

Also, strength generator 536 accepts employment connections from employment connection data 520 and generates, for each employment connection, a strength value reflecting strength of the connection. One of the factors that strength generator 536 may consider is time. The further in the past an employment change, the lower the strength value.

While this embodiment includes asymmetrical strength generator 534, other embodiments include only a single strength generator for people connection data 510. Also, other embodiments might include only people connection data 510 or employment connection data 520, but not both.

Linear combiner 540 accepts multiple strength values generated by one or more of strength generators 532-536 regarding a pair of organizations to generate a result that indicates whether the pair of organizations is related to each other. Linear combiner 540 combines the strength values generated by one or more of strength generators 532-536 with linear combination weights 580 generated by regression model 570. (Initially, the linear combination weights 580 may be manually set. Also, linear combination weights 580 may be only a single weight if there are only two strength generators.) A result generated by linear combiner 540 may be based on a threshold value, such that any output of combining the strength values based on linear combination weights 580 that is greater than the threshold value indicates that the corresponding pair of organizations is related; otherwise, the pair is not related.

User feedback 550 is analyzed to generate labeled data 560. User feedback 550 indicates whether, for each content item, a user clicked on/requested/viewed a content item that is associated with two organizations. Each user interaction with such a content item becomes a training instance where the label indicates that the user interacted with the content item. Also, if a user does not interact with a content item, then a training instance may be generated for that non-event, where the label indicates that the user did not interact with the content item. The feature values of each feature of a training instance are computed and stored with the corresponding label. For example, if a user selected a content item that is associated with organizations A and B, then a training instance is generated to include the label ‘1’ (indicating a user interaction), connection identifier 134 calculates (e.g., in response to a request from a training set generator, not depicted) (1) a number of people connections between organizations A and B and (2) a number of employment connections relative to organizations A and B, and those two numbers are stored in the training instance. Conversely, if a user did not select a content item that is associated with organizations A and B, then a training instance is generated to include the label ‘0’ (indicating no user interaction), connection identifier 134 calculates the number of people connections and the number of employment connections, and those two numbers are stored in the training instance. Once multiple training instances are generated based on user feedback 550, those training instances become labeled data 560, which is used to train regression model 570, which learns one or more linear combination weights for linear combiner 540.

In a related embodiment, user feedback 550 is used (in addition to or instead of learning linear combination weights 580) to learn weights for the features listed above, such as a number of people connections where the connected users have communicated with each other through a messaging service and a number of people connections where at least one of the connected users has viewed the other user's public profile.

Linear combiner 540 uses the one or more linear combination weights to generate results 545 for different pairs of organizations. Results 545 are stored in organization relation database 138. Content item identifier 590 (which is another process or component of server system 130) uses results 545 to determine which content to present to users 595. Some content items that content item identifier 590 selects may be not based on results 545.

Content item identifier 590 may be invoked by another service in server system 130 or by an application executing on a client device that sends parameters that content item identifier 590 uses to determine which content items to select. Examples of parameters include a user/member identifier that identifies a user that is operating the client device, a device identifier that identifies the client device, and one or more contextual identifiers that identify contextual items that appear within currently presented/requested content. Examples of contextual items include a user profile (of a user that is different than the user that is operating the client device) that is currently being presented, a list of users that is currently presented as a result of a person search, an organization profile that is currently being presented, a list of organizations that is currently presented as a result of an organization search, and a list of courses or videos that is currently presented as a result of a video search.

### Improvement to Computer-Related Technology

Embodiments described herein improve computer-related technology pertaining to content item relevance. The more relevant a content item for a user, the more likely the user will click on, or otherwise interact with, the content item. Sophisticated techniques have been implemented to discover relevant content items. However, such techniques have focused on direct similarities of the viewer with a candidate content item. Also, no current techniques have leveraged an online social graph of people connections or employment connections when identifying pairs of related organizations, which is used as a proxy for relevance. Embodiments described herein improve computer processes in identifying relevant information through the use of specific rules to avoid the malicious data manipulation. These embodiments improve an existing technological process for identifying relevant information rather than merely using a computer as a tool to perform an existing process. Embodiments define specific ways to use online networks to not only identify connections and employment-related activities, but to leverage such information to provide relevant electronic content to website visitors.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

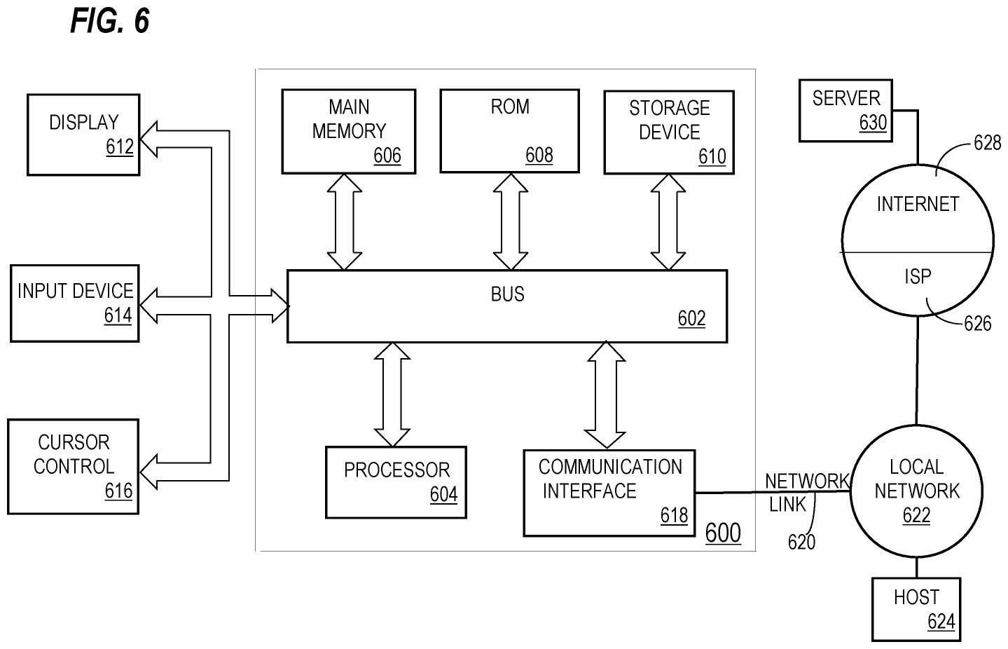

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing connection data that identifies, for each user of a first plurality of users, one or more other users with which said each user has a connection;
storing job change data that identifies, for each user of a second plurality of users, multiple organizations for which said each user has worked or had sought an employment relationship;
based on the connection data, identifying a number of connections between employees of a first organization and employees of a second organization;
based on the job change data, identifying a number of users that listed, in their respective online profiles, the first organization as an employer and either listed the second organization as an employer or applied for employment at the second organization;
based on the number of connections and the number of users, determining whether to identify the first organization and the second organization as related;
wherein the method is performed by one or more computing devices.

2. The method of claim 1, further comprising:
determining a first weight associated with connections between employees of respective organizations;
determining a second weight associated with users who have changed jobs or applied to jobs of different organizations;
applying the first weight to the number of connections to generate a first weighted value;
applying the second weight to the number of users to generate a second weighted value;
wherein determining whether to identify the first organization and the second organization as related is based on the first weighted value and the second weighted value.

3. The method of claim 2, further comprising:
storing training data that comprises a plurality of training instances, each of which includes features associated with two organizations and includes a label that indicates whether the two organizations are related;
using one or more machine learning techniques to train a prediction model based on the training data, wherein training the prediction model comprises determining the first weight and the second weight;
wherein determining whether to identify the first organization and the second organization as related is performed using the prediction model.

4. The method of claim 2, further comprising:
determining to identify the first organization and the second organization as related;
in response to identifying the first organization and the second organization as related, causing one or more content items associated with the first organization or the second organization to be presented to a first plurality of users;
receiving user feedback regarding content items with which a second plurality of users have interacted and includes the one or more content items that were determined based on the first organization being related to the second organization;
based on the user feedback, adjusting the first weight or the second weight.

5. The method of claim 1, wherein:
the connections between employees of the first organization and employees of the second organization comprise a first connection and a second connection;
the method further comprising:
determining a first weight of the first connection and a second weight of the second connection, wherein the first weight is different than the second weight.

6. The method of claim 5, wherein the first weight and the second weight are determined based on one or more factors that includes whether the employees of the first connection communicate with each other, whether employees of the first connection have common profile values, or whether an employee of the first connection interacts with content associated with the other employee of the first connection.

7. The method of claim 1, further comprising:
determining a ratio of (1) the number of connections or the number of users to (2) a size of the first organization or the second organization;
wherein determining whether to identify the first organization and the second organization as related is also based on the ratio.

8. The method of claim 1, further comprising:
storing training data that comprises a plurality of training instances, each of which includes features associated with two organizations and includes a label that indicates whether the two organizations are related;
using one or more machine learning techniques to train a prediction model based on the training data, wherein features of the prediction model comprise one or more of the following:
a first number of connections where each connection was formed in a certain period of time,
a second number of connections where users of each connection have communicated with each other through a messaging service,
a third number of connections where at least one of users of each connection users has viewed a public profile of the other user of said each connection,
a fourth number of connections where at least one of the users of each connection has commented, shared, or liked content authored by the other user of said each connection,
a ratio of the number of connections to a size of one of the two corresponding organizations,
a first number of employment connections that formed in a particular period of time,
a second number of employment connections where one of the two corresponding organizations was only applied to by the corresponding user, or
a ratio of a number of employment connections to a size of one of the two corresponding organizations;
wherein determining whether to identify the first organization and the second organization as related is performed using the prediction model.

9. A method comprising:
storing connection data that identifies, for each user of a first plurality of users, one or more other users with which said each user has a connection;
storing employment data that identifies, for each organization of a plurality of organizations, a second plurality of users that said each organization employs;
based on the connection data and the employment data, for each pair of organizations in the plurality of organizations:
identifying a number of connections between employees of a first organization in said each pair and employees of a second organization in said each pair;
based on the number of connections, determining whether to identify the first organization and the second organization as related;
wherein the method is performed by one or more computing devices.

10. The method of claim 9, further comprising:
determining a ratio of (1) the number of connections to (2) a size of the first organization or the second organization;
wherein determining whether to identify the first organization and the second organization as related is also based on the ratio.

11. The method of claim 9, further comprising:
storing training data that comprises a plurality of training instances, each of which includes features associated with two organizations and includes a label that indicates whether the two organizations are related;
using one or more machine learning techniques to train a prediction model based on the training data, wherein features of the prediction model comprise one or more of the following:
a first number of connections where each connection was formed in a certain period of time,
a second number of connections where users of each connection have communicated with each other through a messaging service,
a third number of connections where at least one of users of each connection users has viewed a public profile of the other user of said each connection,
a fourth number of connections where at least one of the users of each connection has commented, shared, or liked content authored by the other user of said each connection,
a ratio of the number of connections to a size of one of the two corresponding organizations,
a first number of employment connections that formed in a particular period of time,
a second number of employment connections where one of the two corresponding organizations was only applied to by the corresponding user, or
a ratio of a number of employment connections to a size of one of the two corresponding organizations;
wherein determining whether to identify the first organization and the second organization as related is performed using the prediction model.

12. One or more storage media storing instructions which, when executed by one or more processors, cause:
storing connection data that identifies, for each user of a first plurality of users, one or more other users with which said each user has a connection;
storing job change data that identifies, for each user of a second plurality of users, multiple organizations for which said each user has worked or had sought an employment relationship;
based on the connection data, identifying a number of connections between employees of a first organization and employees of a second organization;
based on the job change data, identifying a number of users that listed, in their respective online profiles, the first organization as an employer and either listed the second organization as an employer or applied for employment at the second organization;
based on the number of connections and the number of users, determining whether to identify the first organization and the second organization as related.

13. The one or more storage media of claim 12, wherein the instructions, when executed by the one or more processors, further cause:
determining a first weight associated with connections between employees of respective organizations;
determining a second weight associated with users who have changed jobs or applied to jobs of different organizations;
applying the first weight to the number of connections to generate a first weighted value;
applying the second weight to the number of users to generate a second weighted value;
wherein determining whether to identify the first organization and the second organization as related is based on the first weighted value and the second weighted value.

14. The one or more storage media of claim 13, wherein the instructions, when executed by the one or more processors, further cause:
storing training data that comprises a plurality of training instances, each of which includes features associated with two organizations and includes a label that indicates whether the two organizations are related;
using one or more machine learning techniques to train a prediction model based on the training data, wherein training the prediction model comprises determining the first weight and the second weight;
wherein determining whether to identify the first organization and the second organization as related is performed using the prediction model.

15. The one or more storage media of claim 13, wherein the instructions, when executed by the one or more processors, further cause:
determining to identify the first organization and the second organization as related;
in response to identifying the first organization and the second organization as related, causing one or more content items associated with the first organization or the second organization to be presented to a first plurality of users;
receiving user feedback regarding content items with which a second plurality of users have interacted and includes the one or more content items that were determined based on the first organization being related to the second organization;
based on the user feedback, adjusting the first weight or the second weight.

16. The one or more storage media of claim 12, wherein:
the connections between employees of the first organization and employees of the second organization comprise a first connection and a second connection;
the instructions, when executed by the one or more processors, further cause:
determining a first weight of the first connection and a second weight of the second connection, wherein the first weight is different than the second weight.

17. The one or more storage media of claim 16, wherein the first weight and the second weight are determined based on one or more factors that includes whether the employees of the first connection communicate with each other, whether employees of the first connection have common profile values, or whether an employee of the first connection interacts with content associated with the other employee of the first connection.

18. The one or more storage media of claim 12, wherein the instructions, when executed by the one or more processors, further cause:
determining a ratio of (1) the number of connections or the number of users to (2) a size of the first organization or the second organization;
wherein determining whether to identify the first organization and the second organization as related is also based on the ratio.

19. The one or more storage media of claim 12, wherein the instructions, when executed by the one or more processors, further cause:
storing training data that comprises a plurality of training instances, each of which includes features associated with two organizations and includes a label that indicates whether the two organizations are related;
using one or more machine learning techniques to train a prediction model based on the training data, wherein features of the prediction model comprise one or more of the following:
a first number of connections where each connection was formed in a certain period of time,
a second number of connections where users of each connection have communicated with each other through a messaging service,
a third number of connections where at least one of users of each connection users has viewed a public profile of the other user of said each connection,
a fourth number of connections where at least one of the users of each connection has commented, shared, or liked content authored by the other user of said each connection,
a ratio of the number of connections to a size of one of the two corresponding organizations,
a first number of employment connections that formed in a particular period of time,
a second number of employment connections where one of the two corresponding organizations was only applied to by the corresponding user, or
a ratio of a number of employment connections to a size of one of the two corresponding organizations;
wherein determining whether to identify the first organization and the second organization as related is performed using the prediction model.
